(19) United States
(12) Patent Application Publication
(10) Pub. No.: US 2002/0025218 A1
(43) Pub. Date: Feb. 28, 2002

(54) Insulator

(75) Inventors: Victor Wong Tan, Hamilton (NZ); Bradley John Thompson, Hamilton (NZ)

Correspondence Address: MASON, MASON & ALBRIGHT, 2306 South Eads Street, P.O. Box 2246, Arlington, VA, 22202, US

(73) Assignee: VICTOR WONG TAN

(21) Appl. No.: 09/934,545

(22) Filed: Aug. 23, 2001

Related U.S. Application Data
(63) Continuation of application No. PCT/NZ99/00189, filed on Aug. 31, 2000.

(30) Foreign Application Priority Data
Feb. 23, 1999 (NZ) 334338

(51) Int. Cl. F16D 1/00

(52) U.S. Cl. 403/322.4

(57) ABSTRACT

This invention relates to an insulator including a mounting portion for mounting the insulator to a surface, and a securing portion for securing a length of material relative to the insulator, and a securing portion capable of being moved to release the length of material with respect to the insulator, the insulator characterised in that the movement of the securing portion to allow release of the length of material is contained within the insulator.

### RELATED APPLICATION

This Application is a continuation of International Application No. PCT/NZ99/00189, filed Nov. 12, 1999.

### FIELD OF THE INVENTION

The invention relates to an insulator. In particular, the present invention relates to improvements to insulators used in fencing—whether electric or non-electric. The term insulator is in this specification defined as a fence wire retainer.

### BACKGROUND OF THE INVENTION

Electric fencing insulators are devices which generally comprise a securing portion for securing electrified fence wire and a mounting bracket to enable the insulator to be mounted to a fence post or some other surface.

Ideally, securing the portion is required to withstand vertical and lateral loads of the strained electric fence wire in addition to other loads imposed, for example, by animal contact with the fence.

One of the most cost effective electrically insulated materials from which to make insulators is plastics material. However, plastics material is in general susceptible to wear from movement of wire against it—such as can happen through the action of wind moving wiring against the electric fence insulator. Thus, an ideal securing portion will minimize the wear effects of any movement of the wire against the insulator.

Quite often, it is desirable to have permanent or semi-permanent electric fencing which can be easily disassembled or dropped, particularly when there is considerable stock or vehicle equipment (e.g. grain harvesters, fertilizer spreaders) movement on a farm or a requirement for readily portable security fencing. In such situations there is a requirement to have an electric fence insulator that allows the wire to be readily secured in the insulator, or readily removed therefrom when required to shift or temporarily remove the fencing.

A type of insulator common to the trade which was developed to meet these needs is the Pin-Lock Insulator.

The Pin-Lock Insulator also comprises of a securing portion affixed to a mounting bracket. The securing portion, however, comprises of two arms aligned vertically with each other. Each arm has an aperture which is vertically aligned wit the aperture on the other arm. This arrangement allows a pin to be pushed through the two holes.

Thus, when it is desired to erect the electric fencing, the fence wire passes between the two arms of the insulator and is secured by the pin passing through the arms of the securing portion. To disassemble the electric fencing, the pin needs only to be pulled out from the apertures to allow the wire to be freed with respect to the insulator.

Unfortunately, there are a number of problems associated with these Pin-Lock insulators.

The nature of the plastics material commonly used in the Pin-Lock Insulators means that the pins can be readily distorted and become jammed into the apertures. Considering the large number of insulators typically used by a farmer or on a security system, this fault can be of great frustration to the user.

In many instances, the pin is connected to the insulator by a flexible plastic coupling. However, it is quite common for the coupling to break using the pin to be lost and thus resulting in an unusable insulator.

Another problem with the Pin-Lock Insulators is that a certain degree of coordination and physical strength is required either to insert or release the pin. This can be a considerable source of strain to those having poor coordination, for example, arthritis sufferers and children.

Another problem is that it can be difficult to determine at a distance whether the wire is secured to the insulator or not. The size of the wire and the pin makes it difficult to see whether the wire is engaged in the insulator and the pin is actually through the hole.

Yet another problem with the Pin-Lock Insulators is that the wire bearing surface is such that the insulators are readily worn through the action of the wire moving in the wind. Alternatively, many pins used are ridged and are also readily worn by the wire.

It is an object of the present invention to address the foregoing problems or at least to provide the public with a useful choice.

Further aspects and advantages of the present invention will become apparent from the ensuing description which is given by the way of example only.

### SUMMARY OF THE INVENTION

According to one aspect of the present invention, there is provided an insulator including: a mounting portion for mounting the insulator to a surface; and a securing portion for securing a length of material relative to the insulator; and a securing portion being capable of being moved to release to the length of material with respect to the insulator, the insulator characterized in that the movement of the securing portion to allow release of the length of material is contained within the insulator.

The term “insulator” should be read as any device capable of retaining a length of material used in fencing including material used in electric and non-electric fencing.

Reference throughout this specification should now be made to the length of material as being wire. It should be appreciated, however, that this is a term tended to cover other lengths of material such as rope, tape, braid, mesh and other fencing materials required to be secured by an insulator.

One of the major advantages of the present invention is that by having the movement of a securing mechanism contained within the insulator, there is no removal of the securing mechanism from the insulator. Thus, unlike the typical Pin-Lock Insulator, there is no chance of the securing mechanism becoming lost, thus rendering the insulator unusable.

The present invention may be utilized in a number of embodiments.

In one embodiment of the present invention, there is provided a movable cover attached to the securing portion, which can be moved, swung or slid over the area of the insulator that the wire passes, to secure the wire with respect to the insulator.

In preferred embodiments, the wire is held with respect to the insulator by a securing portion in the form of a rotatable locking mechanism.

In preferred embodiments of the present invention, the rotatable locking mechanism can be withdrawn from the insulator, inverted and then replaced within the insulator in order that the open and secured positions can be reversed.

For example, in one embodiment of the present invention, the locking mechanism may comprise of a rotatable slotted cam fitted within a complementary shaped socket in the insulator.

The slot in the cam is preferably wide enough to accommodate the electric fence wire and allow ready removal of the wire from the insulator when the slot is aligned with a suitable sized opening in the insulator.

To secure the wire with respect to the insulator, it is envisaged that the cam will be rotated so the cam blocks the opening in the insulator from the wire.

The rotation of the cam may be achieved by a number of means. For example, there may be provided gripping surfaces on the outer edges of the cam allowing the user to readily rotate same.

However, in preferred embodiments the cam is rotated by a tab attached to the cam and extending out from the insulator. It should be appreciated that such a tab makes it relatively easy for the user of the insulator to rotate the cam to either secure or release the wire with respect to the insulator.

In some embodiments of the present invention the cam may have a rib, or plurality of ribs, providing some resistance to the movement of the cam with respect to the recess within the insulator. Configured appropriately, a rib or number of ribs, can allow the tab/cam combination to be “locked” in position—whether this is allowing the wire to be secured or unsecured with respect to the insulator. Thus, these embodiments of the present invention allows the tab in some orientations to resist the forces of gravity, vibration or inadvertent contact (for example, animal contact) and remain latched in the open or closed position.

In some embodiments of the present invention where the cam has a rib or number of ribs, these ribs provide a localized contact between the cam and the socket which the cam operates which will reduce the likelihood of any binding occurring, or the severity of any binding due to the present invention becoming soiled in its operating environment.

An alternate or supplementary mechanism to assist the securing of the tab may be external lugs on the securing portion.

It should be appreciated, however, that the present invention could be configured so that the tab/cam arrangement may operate in an essentially horizontal plane, or at alternate angles.

It should be appreciated that the provision of a rib, or plurality of ribs, can also provide a positive feel to the movement of the cam within the recess and will reduce or even eliminate any tendency for the cam to “rattle” when fitted within the insulator.

The visual indication of the tab position makes it easy to see if the insulator is open or closed.

In some embodiments of the present invention, the tab may be color coded thus giving additional capability for the user to tell by which colored surface of the tab is showing whether the insulator is in a secured or open position.

In preferred embodiments of the present invention, the wire bears against the back of the securing portion closest to the mounting bracket when it is in a secured state. It is envisaged that in some embodiments this bearing surface would be curved so as to minimize wear on the insulator from the wire.

It should be appreciated that such cam arrangement whereby the opening of the insulator is blocked by the cam fulfills one of the prime functions of the insulator which is to resist the lateral load applied outwards from the insulator by the strained wire.

It is also to be appreciated that the present invention has a number of advantages over the prior art.

One of the advantages is that the design of the present invention is such that through curved rotating surfaces there is provided minimal chance of wear by the wire on the surfaces.

By having the movement of the securing position within the insulator provides sufficient guidance that minimal coordination is required to operate the insulator.

Further, this feature ensures that the operating part of the securing portion is never lost.

Finally, the use of colored tabs and the actual visibility of the tab position can readily indicate whether the wire is secured or unsecured.

### BRIEF DESCRIPTION OF THE DRAWINGS

Further aspects of the present invention will become apparent from the following description which is given by way of example only and with reference to the accompanying drawings in which:

FIG. 1 is a diagrammatic plan view of an insulator in accordance with one embodiment of the present invention; and

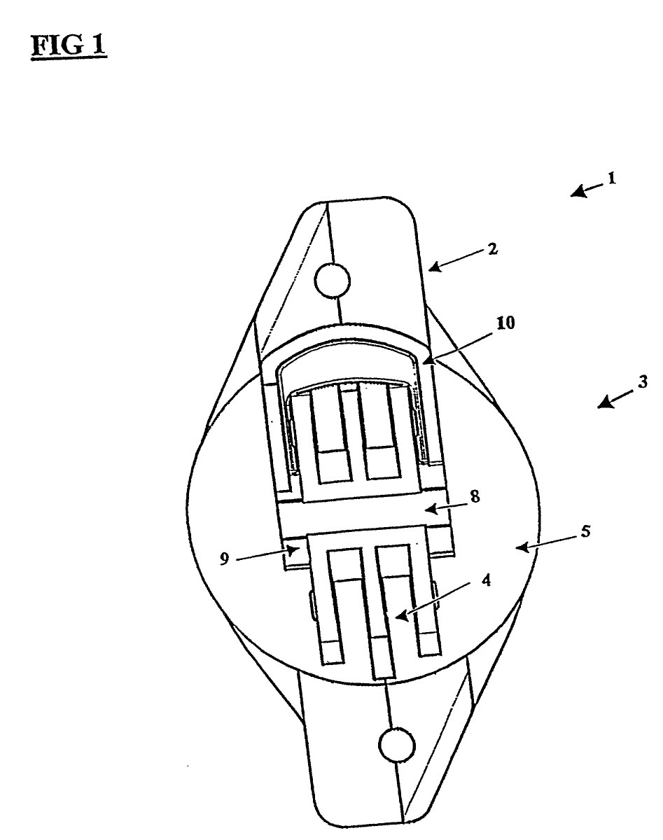

FIG. 2 is a diagrammatic side view of the insulator shown in FIG. 1.

### DETAILED DESCRIPTION OF THE PREFERRED EMBODIMENTS

Aspects of the present invention have been described by way of example only and it should be appreciated that modifications and additions may be made thereto without departing from the scope thereof.

With respect to the drawings, there is provided an insulator generally indicated by arrow 1.

The insulator 1 has a mounting portion 2 and is securing portion generally indicated by arrow 3.

It should be appreciated that mounting portion 2 should be seen as generic and the present invention can be used with a number of different mounting portions 2 depending on the surface to which the insulator is to be mounted. Such mounts include post-mounts, waratahs, strap-on mounts, T-posts and screw-on mounts.

The securing portion 3 has two opposing fingers 4 extending from a backing plate 5 and configured in such a manner as to form a cylindrical recess 6.

Also fitted within recess 6 is a locking mechanism comprising a slotted cam 9 and a tab 10.

A fence wire 7 resides in recess 6 against a curved bearing surface 8 in the cam slot (not clearly shown).

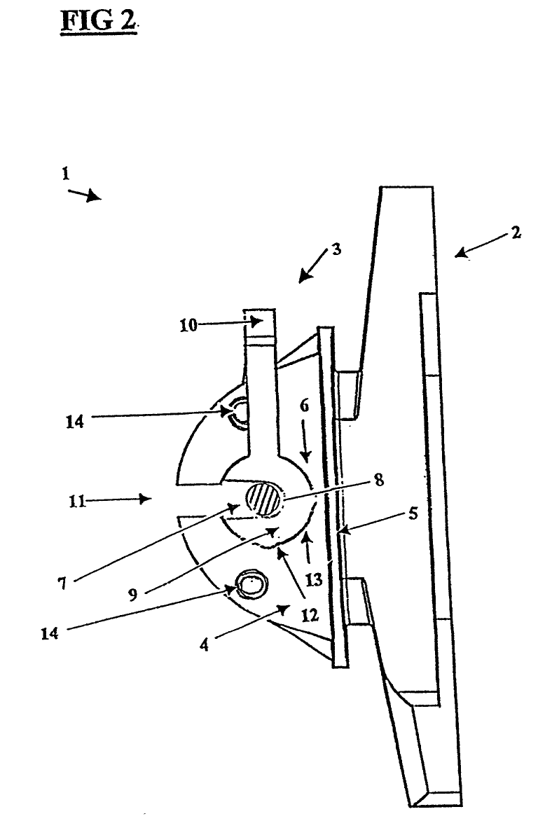

The size of the slot in the cam 9 is such that wire 7 can readily be removed from insulator 1 via the opening 11 between fingers 4 as illustrated in FIG. 2.

Further locking is obtained from lugs 14 which assist to lock tab 10 in the fully open or closed position.

It can be seen that when cam 9 is rotated to prevent movement of wire 7 the aperture 11 arrangement of cam 9 within fingers 4 is such that the tensile loading provided by the wire can be readily resisted by the insulator.

Aspects of the present invention have been described by way of example only and modifications and additions may be made thereto without departing from the scope of the appending claims:

The claims defined by the invention are:

1. An insulator including:
a mounting portion for mounting the insulator to a surface, and
a securing portion for securing a length of material relative to the insulator, and
a securing portion capable of being moved to release the length of material with respect to the insulator,
the insulator characterised in that the movement of the securing portion to allow release of the length of material is contained within the insulator.

2. An insulator as claimed in claim 1 wherein a moveable cover is attached to the securing portion.

3. An insulator as claimed in either claim 1 or claim 2 wherein the securing portion is in the form of a rotatable locking mechanism.

4. An insulator as claimed in claim 3 wherein the rotatable locking mechanism can be inverted in order that the open and secured positions can be reversed.

5. An insulator as claimed in either claim 3 or claim 4 wherein the locking mechanism comprises of a rotatable slotted cam fitted within a complementary shaped socket in the insulator.

6. An insulator as claimed in claim 5 wherein the slot in the cam is wide enough to accommodate the secured material and allow ready removal of the secured material from the insulator when the slot is aligned with a suitable sized opening.

7. An insulator as claimed in claim 6 wherein the cam can be rotated to block the opening in the insulator.

8. An insulator as claimed in claims 5 through 7 wherein the outer edges of the cam may be provided with a gripping surface allowing the user to readily rotate the cam.

9. An insulator as claimed in claims 5 through 8 wherein the cam is rotated by a tab attached to the cam and extending out from the insulator.

10. An insulator as claimed in claim 9 wherein the tab is configured in such a manner that it can assist the rotation of the cam to either the open or secured position with respect to the insulator.

11. An insulator as claimed in claims 9 through 10 wherein the cam includes at least one rib.

12. An insulator as claimed in any one of claims 9 to 11 which includes lugs to assist the securing of the tabs.

13. An insulator as claimed in claims 9, 10 or 12 wherein the tab contains a visual indicator to identify if the insulator is in the open or closed position.

14. An insulator as claimed in claim 13 wherein the indicator consists of a colored area of the tab which is evident when the insulator is in an open position and an area of the tab containing an alternative colored area which is evident when the insulator is in a secured position.

15. An insulator as claimed in any one of the preceding claims wherein a portion of the length of material being secured bears generally against the back of the securing portion, in close proximity to the mounting portion, of the insulator when the insulator is in a secured position.

16. An insulator as claimed in claim 15 wherein the surface against which the length of material is held, has a generally curved profile so as to reduce the wear on this surface by the material.

17. A securing device including:
a mounting portion for mounting the insulator to a surface, and
a securing portion for securing a length of material relative to the securing device, and
a securing portion capable of releasing the length of material with respect to the securing device, the securing device characterised in that the movement of the securing portion to allow release of the length of material is contained within the securing device.

18. An insulating device substantially as herein described with reference to and as illustrated by the accompanying drawings.

19. A securing device substantially herein described with reference to and as illustrated by the accompanying drawings.
